(19) United States
(12) Patent Application Publication
(10) Pub. No.: US 2019/0206307 A1
(43) Pub. Date: Jul. 4, 2019

(54) DISPLAY WITH SWITCHABLE BACKGROUND APPEARANCE

(71) Applicant: X Development LLC, Mountain View, CA (US)

(72) Inventors: Martin Friedrich Schubert, Mountain View, CA (US); Michael Jason Grundmann, San Jose, CA (US)

(21) Appl. No.: 16/011,542

(22) Filed: Jun. 18, 2018

Related U.S. Application Data
(60) Provisional application No. 62/611,383, filed on Dec. 28, 2017.

(51) Int. Cl. G09G 3/32

(52) U.S. Cl. CPC G09G 3/32; G09G 2340/12; G09G 2300/023

(57) ABSTRACT

An electronic display includes an array of pixels each including a light-emitting element, each light-emitting element having a maximum lateral dimension, P_{d}, in a plane of the display and each light-emitting element being separated from the light-emitting element in each adjacent pixel by a distance, D, wherein D≥5P_{d}, the light-emitting elements being arranged to emit light to a viewing side of the display. The electronic display also includes a panel supporting the light-emitting elements, wherein portions of the panel between the light-emitting elements are visible from the viewing side of the display, and the panel is switchable between different optical states. The electronic display further includes a controller in communication with the array of pixels and the panel, the controller being programmed to selectively activate the light-emitting elements to produce an image and to change an appearance of the panel by switching the panel between the different optical states.

### FIELD

The disclosure relates to electronic displays.

### BACKGROUND

Flat panel displays are ubiquitous in today's world, providing critical user interfaces in wearable devices, smart phones, computers, televisions, automobile dashboards, advertising billboards, etc. Typically, such displays are composed of an array of picture elements (pixels), which either emit or transmit variable amounts of light. In full color flat panel displays, color is often spatially synthesized using, e.g., red, green, and blue or cyan, yellow, and magenta subpixels. Most flat panel displays, when not displaying imagery, appear black. As such, when not in use, televisions and computer monitors are often conspicuous black rectangles hanging on walls or standing on desks.

### SUMMARY

Electronic displays are disclosed that provide full-color image rendering with a switchable background appearance. Such displays are attainable using micro-light emitters, such as micro-LEDs. Due to their very small size and high efficiency, micro-LEDs can be arrayed with a low fill-factor when compared to other display technologies, making them imperceptible to the naked eye when turned off. Accordingly, sparsely-arrayed micro-LED displays can be stacked on top of another switchable panel that is visible to a viewer when the micro-LEDs are switched off. The switchable panel can have one appearance during operation of the micro-LED display, and a different appearance while the micro-LED display is switched off. For example, when powered on, the micro-LEDs can provide a full-color appearance with a brightness comparable to a conventional display. Generally, the switchable substrate is black when the micro-LED pixels are activated, providing dynamic, full-color images with high contrast. However, the switchable substrate allows the appearance of the display to vary when the micro-LEDs are in the off state. For example, the substrate can be transparent when the micro-LEDs are off, allowing a viewer to see through the display to whatever is behind the display. In some embodiments, the substrate can adopt a different color, e.g., one that matches the color of the wall on which the display is mounted.

In some embodiments, the switchable substrate is itself a display, capable of providing various images when the micro-LED display is off. For example, bi-stable, reflective displays (e.g., dielectrophoretic displays or cholesteric LCDs) can be used to provide static or varying imagery while consuming very little power. Taking advantage of the fact that the appearance of the micro-LED display is independent of that of the switchable substrate, the device can operate as two separate displays at the same time by powering only a portion of each display in the stack.

In one aspect, the invention features an array of pixels each including a light-emitting element, each light-emitting element having a maximum lateral dimension, P_{d}, in a plane of the display and each light-emitting element being separated from the light-emitting element in each adjacent pixel by a distance, D, wherein D≥5P_{d}, the light-emitting elements being arranged to emit light to a viewing side of the display. The electronic display also includes a panel supporting the light-emitting elements, wherein portions of the panel between the light-emitting elements are visible from the viewing side of the display and the panel is switchable between different optical states. The electronic display further includes a controller in communication with the array of pixels and the panel, the controller being programmed to selectively activate the light-emitting elements to produce an image and to change an appearance of the panel by switching the panel between the different optical states.

Embodiments of the electronic display can include one or more of the following features and/or one or more features of other aspects. For example, the electronic display can include different optical states including a first state in which the panel can be transparent and a second state in which the panel can be opaque. As another example, the panel can be black in the second state. In other embodiments, the electronic display can be transparent when the panel is in the first state.

In other embodiments, when the electronic display is in a first display state, the controller can selectively activate the light-emitting elements to display an image and the panel can be in a first of the different optical states. When the electronic display is in a second display state, the light-emitting elements can be switched off and the panel can be in a second of the different optical states.

In some embodiments, the panel can include a second array of pixels each separately switchable between different optical states.

In other embodiments, each pixel of the electronic display can include a plurality of subpixels each comprising a light-emitting element of different colors. Each pixel can include a red, green, and blue light-emitting element or a cyan, magenta, and yellow light-emitting element. In other embodiments, each light-emitting element can be arranged in a corresponding aperture, the aperture being transparent to incident light. The aperture can also have at least one dimension that can be at least five times or more larger than a corresponding dimension of the corresponding light-emitting element. In addition, the aperture can have two perpendicular dimensions that can be at least five times or more larger than corresponding dimensions of the corresponding light-emitting element. The aperture can also have an area that can be 10 times or more larger than a corresponding area of the corresponding light emitting element, as well as an area that can be 50 times or more larger than a corresponding area of the corresponding light emitting element.

In some embodiments the light-emitting elements are light-emitting diodes, while in other embodiments, the light-emitting diodes are μLEDs.

As an example, the light-emitting elements can have a maximum lateral dimension of 50 μm or less.

As another example, the light-emitting elements can have a maximum lateral dimension of 10 μm or less.

In some embodiments, the panel of the electronic display can include the second array of pixels that constitutes a reflective display, a transmissive display, or an emissive display.

Other features and advantages will be apparent from the description below and the drawings.

### BRIEF DESCRIPTION OF THE DRAWINGS

FIG. 1 shows a perspective view of a display, according to an embodiment.

FIG. 2A shows a front view of a single pixel of the display shown in FIG. 1.

FIG. 2B shows a cross sectional view of the single pixel of the display shown in FIG. 1.

FIG. 3 is a cross sectional view of the display shown in FIG. 1 in which an optically switchable layer of the display is opaque.

FIG. 4 is a cross sectional view of the display shown in FIG. 1 in which an optically switchable layer of the display is transparent.

FIG. 5 is a cross-sectional view of a display in which an optically switchable layer of the display includes a plurality of individually addressable pixels.

FIG. 6 is a front view of the display shown in FIG. 5 in which the front panel of the display is in the off state and a rear panel of the display is showing an image.

FIG. 7 is a front view of the display shown in FIG. 5 in which a portion of the device is showing an image with the front panel of the display while another portion of the device is showing an image with the rear panel of the display.

FIG. 8 is a schematic of the front panel of the display shown in FIG. 1.

FIG. 9 is a schematic diagram of an embodiment of a display.

FIG. 10 is a schematic diagram of an embodiment of a computer system.

### DETAILED DESCRIPTION

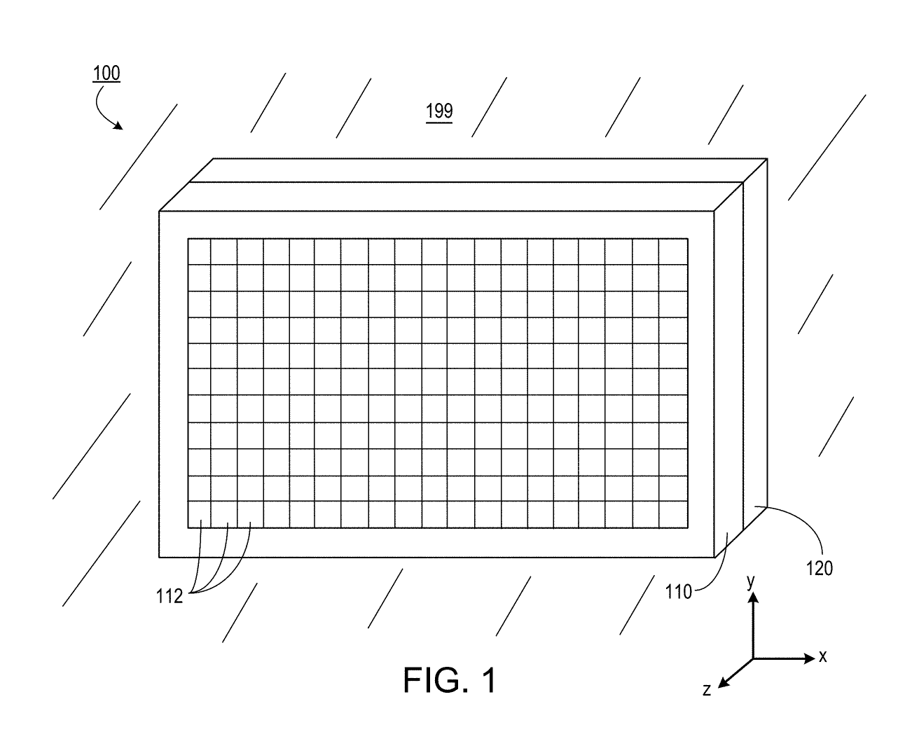

FIG. 1 shows a perspective view of a display 100 mounted on a wall 199. A three-dimensional Cartesian coordinate system is provided for ease of reference. Display 100 is a flat panel display extending in the X-Y plane, where Y is the vertical and X the horizontal viewing directions, respectively. In general, display 100 is often best viewed along the Z-axis or along a direction relatively close to the Z-axis, although displayed images may be viewed from most any location in the hemisphere centered on the Z-axis.

In general, the size and resolution of display 100 can vary. Typically, display 100 has a diagonal dimension in a range from about 25 inches to about 150 inches, although the disclosed technology can be applied to smaller and larger displays. Resolution can be UXGA, QXGA, 480p, 1080p, 4K UHD or higher, for example.

Moreover, while display 100 is depicted as being mounted on wall 199, more generally the technology disclosed can be implemented in other environments, such as, for example, desktop monitors, billboard displays, mobile devices (e.g., handheld devices, such as smartphones and tablet computers), wearable computers (e.g., smartwatches), etc.

Display 100 includes a front panel 110 and a rear panel 120, which both include optically switchable layers and are capable of independently changing their appearance to a viewer. Front panel 110 includes an array of pixels 112 surrounded by a bezel. During operation, front panel 110 operates as a high-resolution (e.g., 1080p, 4K or higher), full-color display capable of delivering video images (e.g., at frame rates of 30 Hz or more, 60 Hz or more, 120 Hz or more). When idle, front panel 110 is substantially transparent allowing a viewer to see through to rear panel 120.

Separately, the appearance of rear panel 120 can switch between different optical states. For example, in one state, rear panel 120 appears black and in another state, transparent. In this way, when front panel 110 is idle, rear panel 120 can appear transparent too. Accordingly, viewers see through the display to wall 199 behind, allowing the display to blend into wall 199. On the other hand, rear panel 120 can be switched to a black state during operation of front panel 110, allowing display 100 to deliver full-color video images with high contrast.

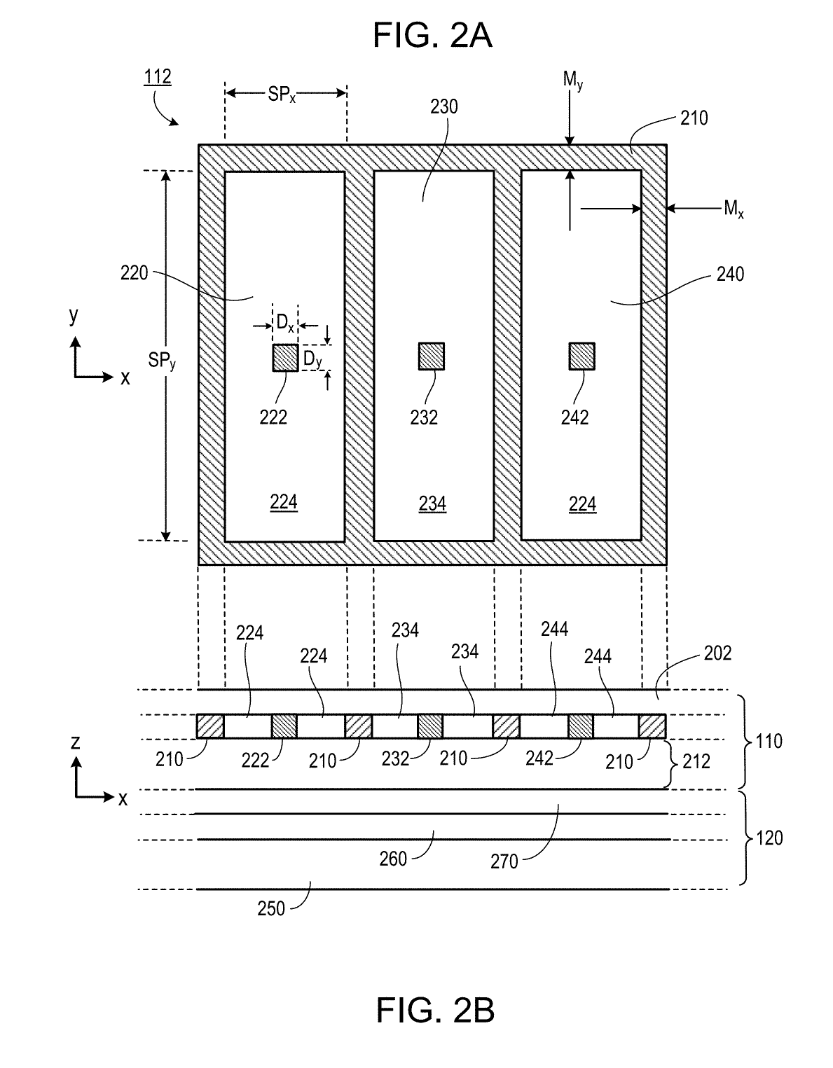

Referring to FIG. 2A, each pixel 112 includes three subpixels, namely, a red subpixel 220, a green subpixel 230, and a blue subpixel 240. Each subpixel is made up of a corresponding light-emitting element and a subpixel aperture, shown here as light-emitting elements 222, 232, and 242, and subpixel apertures 224, 234, and 244, respectively. A black matrix 210 surrounds each subpixel. Black matrix 210 is a dark-colored material that surrounds each subpixel aperture 224, 234, and 244 and absorbs incident light. Black matrix 210 can be made of one or more materials including a metal and oxide layer, such as chromium and chromium oxide, a dark-colored plastic, or a dark-colored resin. Subpixel apertures 224, 234, and 244 are transparent areas of each subpixel that allow the passage of light incident on front panel 110 from either the front (viewer side) or back (wall side).

The width of each subpixel aperture is denoted by the distance SPₓ, measured in the x-direction. The height of each subpixel aperture is denoted by vertical distance SP_{y}, measured in the y-direction. Generally, these dimensions depend on the size of the display and its resolution. For example, a 110 inch (diagonal) display with 1080p resolution has a pixel density of approximately 20 dpi, which corresponds to a pixel width of about 1,200 μm. On the other hand, a 20 inch display with a 4K resolution has a pixel density of about 220 dpi, which corresponds to a pixel width of about 115 μm. Accordingly, SP_{y} can be in a range from about 30 μm to about 400 μm and SPₓ can be in a range from about 10 μm to about 130 μm. As shown for red light-emitting element 222, the width of each light-emitting element is denoted by Dₓ, measured in the x-direction, while the height of each light-emitting element is denoted by D_{y}, measured in the y-direction. In general, the subpixel aperture is much larger than the size of the light-emitting elements in at least one dimension. For instance, SPₓ can be much larger than Dₓ, and/or SP_{y} can be much larger than D_{y}. For example, SPₓ and SP_{y} can be more than 5 times larger than Dₓ and D_{y}, respectively (e.g., 8 times or more larger, 10 times or more larger, 15 times or more larger). By area, the relative size of a subpixel aperture to a light-emitting element (in the X-Y plane) is large. For example, the subpixel aperture area can be about 25 times or more larger than the light-emitting element area (e.g., 50 times or more, 100 times or more).

The small size of the light-emitting elements relative to the subpixel apertures also means that each light-emitting element has a maximum lateral dimension (e.g., a diagonal dimension in the case of a square element, such as that shown in FIG. 2A) that is small compared to the separation between like-colored light-emitting elements in adjacent pixels. For example, the lateral separation (i.e., in the X-Y plane as shown), D, of like-colored light-emitting elements in adjacent pixels can be five or more (e.g., 8 or more, 10 or more, 12 or more, 15 or more) times larger than a maximum lateral dimension, P_{d}, of the light-emitting elements.

As previously mentioned, incident light can pass through subpixel apertures 224, 234, and 244, after which this light can be reflected off the elements of rear panel 120. The reflected light can then pass through subpixel apertures 224, 234, and 244. Light-emitting elements 222, 232, and 242 are small enough in comparison to subpixel apertures 224, 234, and 244 so as not to visibly obscure the reflected light, when the display 100 is viewed by the naked eye.

The dimensions of black matrix 210 are generally relatively small compared to the subpixel dimensions so that the majority of the area of pixel 112 is made up of the subpixel apertures. As shown, the width, measured in the x-direction, of the vertical segments of black matrix 210 is denoted as Mₓ, while the width, measured in the y-direction, of the horizontal segments is denoted as M_{y}. Both Mₓ and M_{y} are small enough that black matrix 210 is not visible to the naked eye of a viewer of display 100. For example, the distances Mₓ and M_{y} can be on the order of 20 μm or less.

FIG. 2B shows a cross-sectional view of pixel 112. In particular, FIG. 2B shows elements of front panel 110, introduced with regard to FIG. 2A, including black matrix 210, subpixels 222, 232, and 242, and subpixel apertures 224, 234, and 244.

Red light-emitting element 222, green light-emitting element 232, and blue light-emitting element 242 are each components that produce correspondingly colored light, with variable intensity. In some embodiments, light-emitting elements 222, 232, and 242 are micro-light-emitting diodes (μLEDs), which refer to microscopic LEDs. Typically, μLEDs are composed of epitaxially-grown inorganic semiconductor layers (e.g., GaN) arranged to form a P-N junction with a bandgap corresponding to a desired spectral band. Charge carriers are injected via electrical contacts on opposing sides of the junction. The charge carriers recombine at the junction to emit a photon within the desired spectral band. In addition to having microscopic lateral dimensions, μLEDs can be extremely thin, e.g., having a thickness of 10 μm or less (in the Z-direction). Other types of light-emitting elements can also be used, such as, e.g., organic light-emitting diodes (OLEDs), lasers, and elements that produce light from phosphor.

Front panel 110 also includes a front panel top layer 202 and a front panel substrate 212. Front panel top layer 202 is a transparent protective layer, which encapsulates the underlying components, structurally supporting them and protecting them from environmental contaminants. Generally, front panel top layer 202 and front panel substrate 212 are made from materials at visible wavelengths, such as a plastic or glass.

Regarding rear panel 120, display 100 also includes a rear panel substrate 250 which supports an optically switchable layer 260 and a rear panel top layer 270. Rear panel top layer 270 and rear panel substrate 250 are analogous in form and function to front panel top layer 202 and front panel substrate 212, respectively. Optically switchable layer 260 is an electro-optic layer that is switchable between a transparent state and an opaque state.

In some embodiments, optically switchable layer 260 can alter its appearance from transparent to translucent or from one solid color to another solid color. In addition, optically switchable layer 260 could both alter its appearance from one solid color to another solid color, and appear as a shade in a gradient between the two solid colors. Optically switchable layer 260 can be made of one or more electro-optic technologies. In some embodiments, the optically-switchable layer can include a layer of a liquid crystal (LC) material (e.g., a nematic LC arranged in a twisted nematic mode, or a vertically aligned LC layer) between two absorptive linearly-polarizing layers (e.g., with crossed transmission axes). Optically switchable layer 260 can also include smart glass or switchable glass materials, such as suspended particle devices, electrochromic devices, and electrophoretic devices. Optically switchable layer 260 can also include one or more mechanically-powered technologies such as two polarizers that can be moved mechanically to vary the amount of polarization of light passing through them.

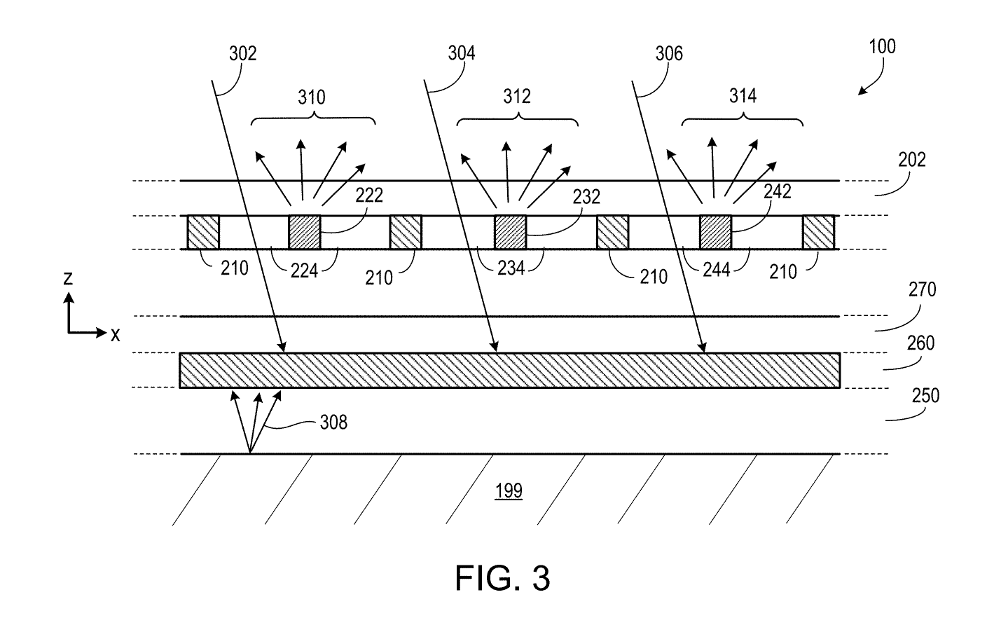

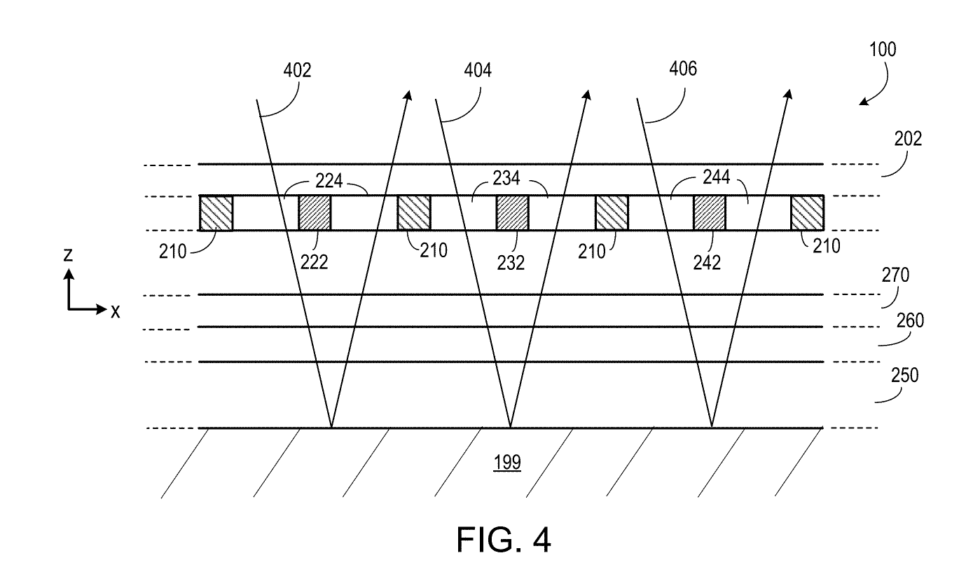

Display 100 has two principal modes of operation, which are illustrated in FIGS. 3 and 4. Referring specifically to FIG. 3, in one mode of operation, light-emitting elements 222, 232, and 242 are activated and emit varying intensities of red, green, and blue light, respectively, through top layer 202. The emitted red, green, and blue light is illustrated by rays 310, 312, and 314, respectively. Meanwhile, optically switchable layer 260 is optically opaque, having a black appearance. In this mode of operation, display 100 operates as a full-color display capable of rendering high-contrast images, including video images at a refresh rate corresponding to the switching speed of the light-emitting elements.

In this mode, ambient light (illustrated by rays 302, 304, and 306) passes through front panel top layer 202, subpixel apertures 224, 234, and 244, front panel substrate 212, and rear panel top layer 270, to reach optically switchable layer 260, where it is absorbed. Similarly, optically switchable layer 260 absorbs any light reflected by wall 199 (illustrated by rays 308). Because optically switchable layer 260 absorbs ambient light, display 100 appears dark when the light-emitting elements in any pixel are in a black state, providing high contrast imagery.

Referring to FIG. 4, in display 100's other principal mode, light-emitting elements 222, 232, and 242 are inactive. Ambient light (illustrated by rays 402, 404, and 406) passes through front panel top layer 202 and subpixel apertures 224, 234, and 244. This light then passes through the remaining layers of front panel 110 and rear panel 120 to wall 199, where it is reflected. The reflected light again traverses rear panel 120 and front panel 110, exiting display 100 through subpixel apertures 224, 234, and 244, and front panel top layer 202. Because of the sizes of the dimensions of black matrix 210 and light-emitting elements 222, 232, and 242, the majority of the ambient light that enters display 100 is able to exit the device without being significantly impeded by these components, as is illustrated by the rays 402, 404, and 406 entering display 100, being reflected of wall 199, and subsequently exiting the device. Therefore, when optically switchable layer 260 is transparent, wall 199 is visible to a viewer through display 100.

While subpixels 220, 230, and 240 are rectangular in FIG. 2A, other shapes are also possible. For example, the subpixels can be square, trapezoidal, hexagonal, etc. Moreover, the light-emitting elements need not be positioned in the middle of each subpixel aperture. In some embodiments, the light-emitting elements are positioned on an edge or in a corner of its subpixel aperture.

Also, while pixel 112 is composed of red, green, and blue subpixels, other colors are also possible. For example, cyan, yellow, and magenta subpixels can be used. In some embodiments, each pixel is composed of more than three different colored subpixels. Monochrome pixels, e.g., having only a single light-emitting element in a single pixel aperture, are also possible.

In display 100, rear panel 120 includes a uniformly switchable layer. In some embodiments, the rear panel itself can be pixelated, allowing the rear panel to display imagery independent of the images displayed on front panel 110.

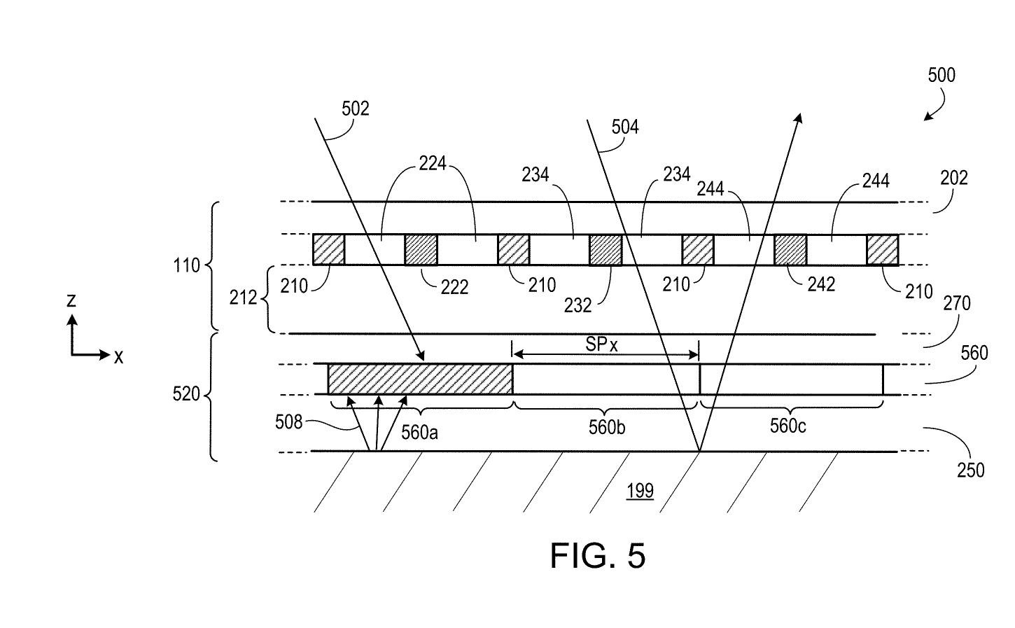

FIG. 5 is a cross-sectional view of a display 500 showing an embodiment in which the device includes the previously described front panel 110 along with a rear panel 520. Rear panel 520 features an optically switchable layer 560 which includes optically switchable pixels 560a, 560b, and 560c. Rear panel 520 also includes rear panel substrate 250 and rear panel top layer 270.

In this embodiment, the resolution of rear panel 520 is the same as that of front panel 110. Each pixel of optically switchable layer 560 lines up with one of the spaces defined by subpixel aperture 224, 234, or 244 so that the pixel can be viewed through the space formed by the aperture. This alignment can also reduce any Moiré effects that may arise from patterning the pixels of optically switchable layer 560 under black matrix 210. In accordance with this configuration, the x and y dimensions of each pixel of optically switchable layer 560 is approximately equal to SPₓ and SP_{y}, respectively. In some embodiments, the pixels of optically switchable layer 560 are separated by a black matrix similar to black matrix 210 that surrounds subpixel apertures 224, 234, and 244. In these embodiments, the black matrix that surrounds the pixels of optically switchable layer 560 aligns with black matrix 210, so as to reduce any Moiré effects that arise from layering the two black matrices.

Each pixel of optically switchable layer 560 can change its optical properties independently of the other pixels that comprise this layer. For example, a plurality of pixels of optically switchable layer 560 can be opaque, in accordance with optically switchable layer 260 of display 100, described in FIG. 3, while another plurality of pixels can be transparent, in accordance with optically switchable layer 260 of display 100, described in FIG. 4. As an example of this, FIG. 5 shows an optically switchable pixel 560a which is in an opaque state. A ray of ambient light (illustrated by ray 502) enters display 500 where it is incident upon pixel 560a. Because pixel 560a is opaque, it absorbs ray 502. Ambient light that is reflected of wall 199 and incident on pixel 560a (illustrated by rays 508) is also absorbed. FIG. 5 also shows optically switchable pixels 560b and 560c which are in a transparent state. Optically switchable pixels 560b and 560c allow ambient light (illustrated by ray 504) to pass through them to be reflected off of wall 199.

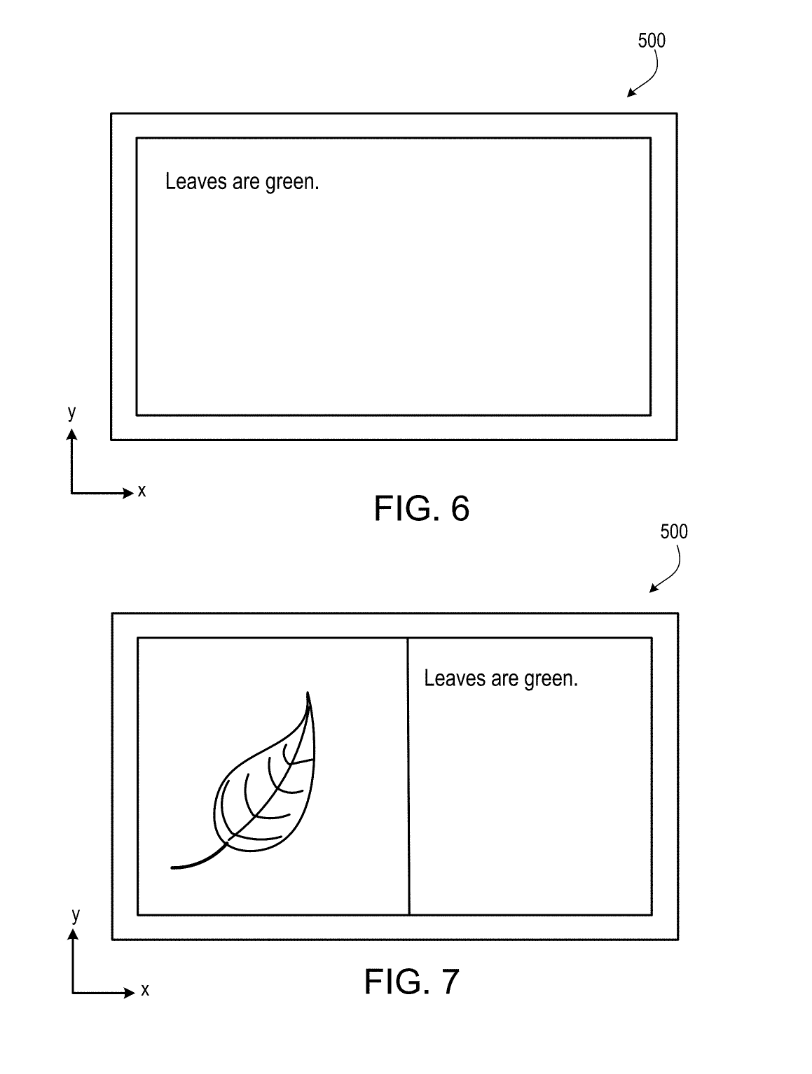

FIG. 6 shows a front view of a display 500 that includes front panel 110 and rear panel 520. Front panel 110 is in the off state while rear panel 520 is displaying an image using the pixels of optically switchable layer 560. Rear panel 520 produces this image by addressing each pixel of optically switchable layer 560. The pixels of optically switchable layer 560 can be configured to allow rear panel 520 to display a monochrome image. Rear panel 520 can also be configured to display full-colored images. In some embodiments, optically switchable layer 560 is made of an electrophoretic material, for example, electronic paper, which is able to maintain an image indefinitely without electricity. In these embodiments, display 500 can show an image on rear panel 520 while the light-emitting elements of front panel 110 are in the off state, therefore consuming little to no power. Examples of images that display 500 can show while consuming little to no power include text, a work of art, or a welcome sign.

FIG. 7 shows a front view of a display 500 that includes front panel 110 and rear panel 520. In this embodiment, a portion of display 500 shows an image with front panel 110 while another portion of the device displays an image with rear panel 520. In this figure, a plurality of light-emitting elements 222, 232, and 242 are in the on state, while a second plurality of these components are in the off state. Also in this embodiment, a plurality of the pixels of optically switchable layer 560 are opaque, while a second plurality display an image. The portion of display 500 that shows an image using front panel 110 corresponds to a portion in which the plurality of light-emitting elements 222, 232, and 242 that are in the on state align with the plurality of pixels of optically switchable layer 560 that are opaque. In other words, this portion of display 500 operates in accordance with the embodiment discussed with regard to FIG. 3. The portion of display 500 that shows an image using rear panel 520 corresponds to that in which the plurality of light-emitting elements 222, 232, and 242 that are in the off state align with the plurality of pixels of optically switchable layer 560 that display an image. In other words, this portion of display 500 operates in accordance with the embodiment discussed with regard to FIG. 6.

As an example of the operation of display 500, a portion of the device can be used to show an image or a video using front panel 110, while another portion of display 500 can be used to show text from an electronic book using rear panel 520. As another example, optically switchable layer 560 can appear transparent, so that rear panel 520 is transparent. In this example, display 500 can use front panel 110 to show the current time, date, and weather superimposed on the otherwise transparent display 500.

In general, the displays described above also include electrode layers connecting each optically-active element with a display driver module. Electrode layers are formed from a transparent electrically-conducting material, such as indium tin oxide (ITO).

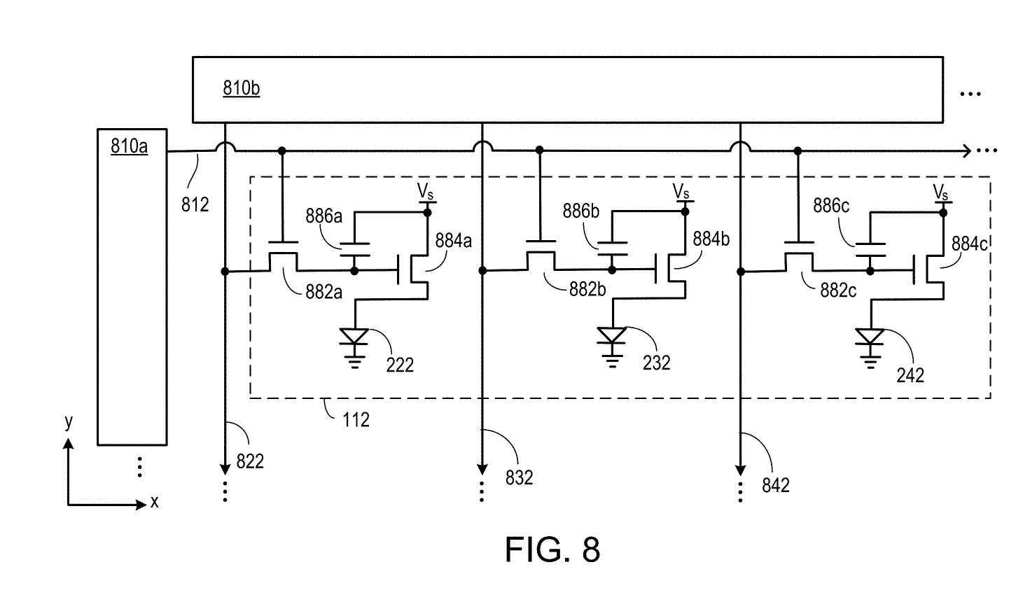

Furthermore, one or more of the panels forming display 100 and/or display 500 can include active addressing, where the signal sent to each light-emitting element is controlled using a corresponding thin-film transistor. For example, FIG. 8 is a schematic of front panel 110. Electrical components shown in FIG. 8 include a front panel select driver 810a, a front panel data driver 810b, light-emitting elements 222, 232, and 242, thin-film transistors (TFTs) 882a, 882b, 882c, 884a, 884b, and 884c, and capacitors 886a, 886b, and 886c. The electrical components can be small enough so as not to be visible to a viewer of the device. They can also be placed underneath or on top of black matrix 210, as well as underneath or on top of light-emitting elements 222, 232, and 242. Signal lines shown in FIG. 8 include front panel select signal line 812, as well as front panel data signal lines 822, 832, and 842. One of front panel select signal lines 822, 832, or 842 is said to be “activated” when front panel select driver 810a is outputting a signal on that line. Similarly, one of front panel data signal lines 822, 832, and 842 is said to be activated when front panel data driver 810b is outputting a signal on that line. The widths of the signal lines can be small enough so as not to be visible to a viewer of the device.

Drivers 810a and 810b are integrated circuits that control the light output of pixel 112 by managing the power supplied to the pixel. Together, front panel select driver 810a and front panel data driver 810b selectively turn on light-emitting elements 222, 232, and 242 and control the brightness of light output by these elements. Front panel data driver 810b is responsible for outputting a data signal to the source terminals of TFTs 882a, 882b, and 882c. The data signal can be a voltage that controls the magnitude of current allowed to flow through each light-emitting element 222, 232, and 242. Increasing the magnitude of the current flowing through light-emitting elements 222, 232, and 242 results in an increase in element brightness. Front panel select driver 810a determines whether the gate terminals of TFTs 884a, 884b, and 884c receive the data signal output by front panel data driver 810b.

To turn on red light-emitting element 222, front panel data driver 810b outputs a data signal to the source terminal of TFT 882a using front panel data signal line 822. Meanwhile, front panel select driver 810a outputs a select signal to the gate terminal of TFT 882a using front panel select signal line 812. The select signal turns on TFT 882a allowing the data signal to pass from front panel data driver 810b through TFT 882a to the gate terminal of TFT 884a. The data signal turns on TFT 884a allowing current to flow from a voltage source, denoted as Vs, through TFT 884a and through red light-emitting element 222. When TFT 882a is turned on, the data signal output by front panel data driver 810b also charges capacitor 886a. When TFT 882a is turned off, the data signal voltage stored by capacitor 886a can ensure TFT 884a remains on, therefore allowing light-emitting element 222 to remain on when TFT 882a is off i.e., when the data signal itself cannot turn on TFT 884a. In other words, light-emitting element 222 can remain in the on state while data signal line 822 is deactivated. Front panel data driver 810b can cycle through front panel data driver lines 822, 832, and 842, activating each one of these lines for a certain time interval. So long as capacitors 886a, 886b, and 886c can maintain a sufficient voltage to keep TFTs 884a, 884b, and 884c in the on state for longer than it takes data driver 810b to complete a full cycle through front panel data driver lines 822, 832, and 842, all three light-emitting elements 222, 232, and 242 can remain in the on state during the cycle.

Just as front panel 110 can be actively addressed using the schematic described with regard to FIG. 8, rear panel 520 can be actively addressed in a similar way. It is also possible for either or both front panel 110 and rear panel 520 to be passively addressed.

As noted previously, the disclosed displays are controlled by drivers that deliver signals to each subpixel coordinating their operation so that the device displays the desired images. In general, the drivers and electronic components that interface with the drivers can be housed in the same housing as the display and/or can be contained in a separate housing.

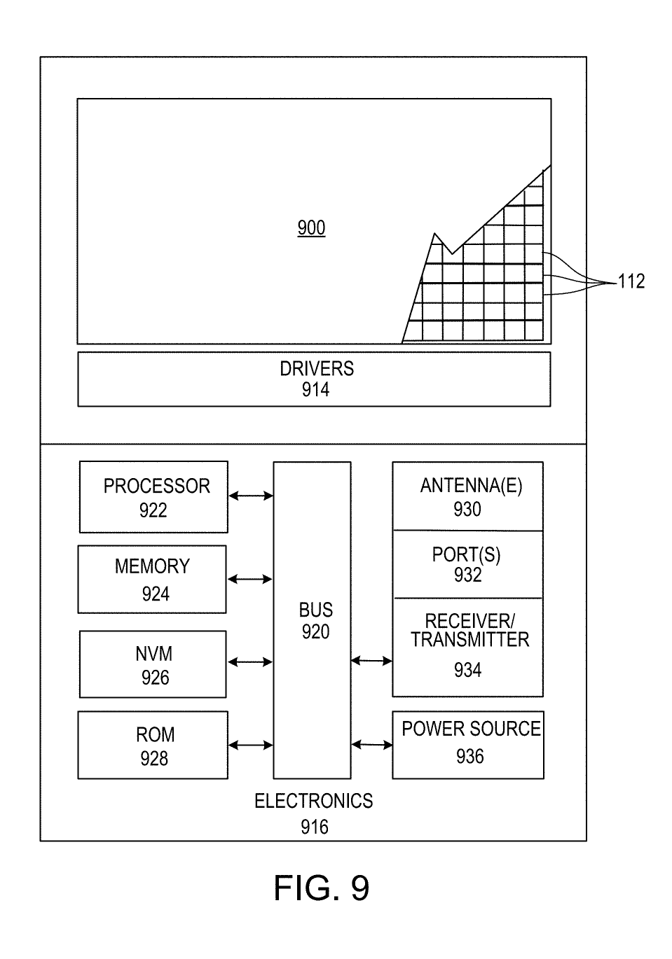

FIG. 9 is a schematic diagram of a display that includes drivers 914 and electronics 916. In general, drivers 914 can include any number of drivers used to control the pixels of a front panel or a rear panel, as previously described. The quantity of drivers included in drivers 914 depends on the driving scheme, e.g., active addressing or passive addressing, as well as the number of panels included in the display. For example, with regard to a display that includes an actively addressed front panel and an actively addressed rear panel, drivers 914 can include both a front panel and rear panel select driver, and both a front panel and rear panel data driver.

Electronics 916 includes a processor 922 coupled to bus 920, to provide control instructions for the display. Generally, processor 922 can include one or more processors or controllers, including one or more physical processors and one or more logical processors. General-purpose processors and/or special-processor processors can be used.

Electronics 916 further includes a random access memory (RAM) or other dynamic storage device or element as a main memory 924 for storing information and instructions to be executed by processor 922. Electronics 916 also includes a non-volatile memory (NVM) 926 and a read-only memory (ROM) 928 or other static storage device for storing static information and instructions for the processor.

Electronics 916 also includes one or more transmitters or receivers 934 coupled to bus 920, as well as one or more antenna(e) 930 and one or more port(s) 932. Antennae 930 can include dipole or monopole antennae, for the transmission and reception of data via wireless communication using a wireless transmitter, receiver, or both. Ports 932 are used for the transmission and reception of data via wired communications. Wireless communication includes, but is not limited to, Wi-Fi, Bluetooth™, near field communication, and other wireless communication standards. Wired communication includes, but is not limited to, USB® (Universal Serial Bus) and FireWire® ports.

Electronics 916 can also include a battery or other power source 936, which may include a solar cell, a fuel cell, a charged capacitor, near field inductive coupling, or other system or device for providing or generating power for electronics 916. The power provided by power source 936 may be distributed as required to elements of electronics 916.

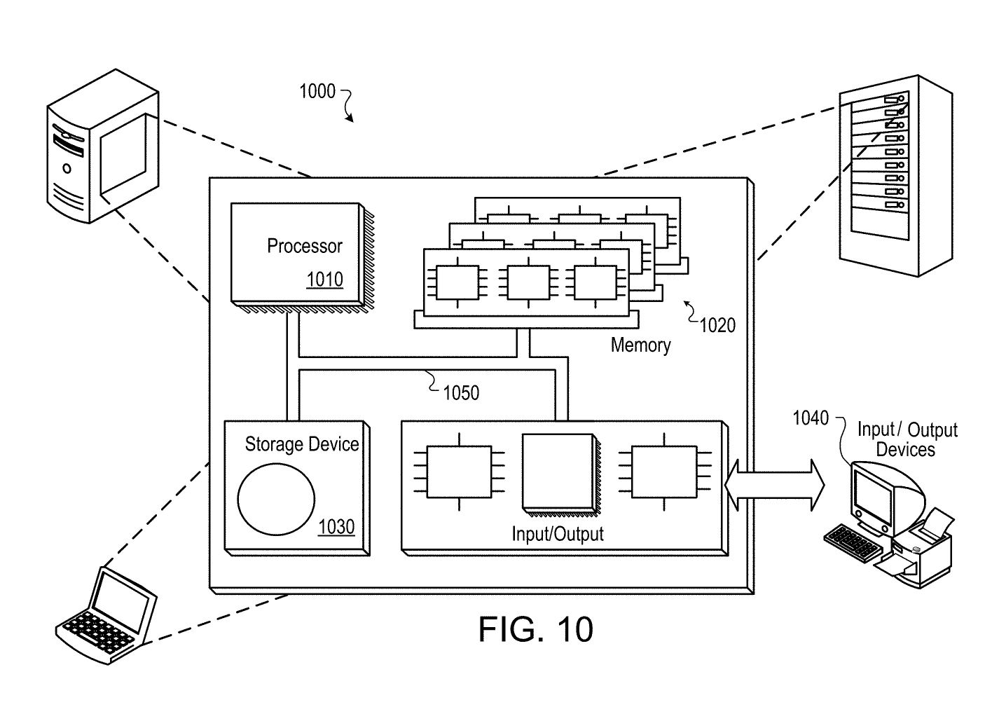

In some embodiments, the foregoing displays are interfaced with or form part of a computer system. FIG. 10 is a schematic diagram of an example computer system 1000. The system 1000 can be used to carry out the operations described in association with the implementations described previously. In some implementations, computing systems and devices and the functional operations described above can be implemented in digital electronic circuitry, in tangibly-embodied computer software or firmware, in computer hardware, including the structures disclosed in this specification (e.g., system 1000) and their structural equivalents, or in combinations of one or more of them. The system 1000 is intended to include various forms of digital computers, such as laptops, desktops, workstations, personal digital assistants, servers, blade servers, mainframes, and other appropriate computers, including vehicles installed on base units or pod units of modular vehicles. The system 1000 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. The processor may be designed using any of a number of architectures. For example, the processor 1010 may be a CISC (Complex Instruction Set Computers) processor, a RISC (Reduced Instruction Set Computer) processor, or a MISC (Minimal Instruction Set Computer) processor.

In some implementations, the processor 1010 is a single-threaded processor. In other implementations, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. For example, while the foregoing displays are depicted as direct view displays (e.g., televisions or computer monitors), other implementations are possible. For instance, the disclosed technologies can be implemented in displays for handheld devices, automotive displays, wearable displays (e.g., head mounted displays), and/or avionic displays (e.g., either in cockpit displays or in-flight entertainment systems). In some embodiments, either or both of the panels are formed with minimal or no black matrix. For example, in certain embodiments, electrical components can be positioned beneath the light emitting elements in each subpixel, eliminating the need to obscure them using black matrix material.

What is claimed is:

1. An electronic display, comprising:
an array of pixels each comprising a light-emitting element, each light-emitting element having a maximum lateral dimension, P_{d}, in a plane of the display and each light-emitting element being separated from the light-emitting element in each adjacent pixel by a distance, D, wherein D≥5P_{d}, the light-emitting elements being arranged to emit light to a viewing side of the display;
a panel supporting the light-emitting elements, wherein portions of the panel between the light-emitting elements are visible from the viewing side of the display and the panel is switchable between different optical states; and
a controller in communication with the array of pixels and the panel, the controller being programmed to selectively activate the light-emitting elements to produce an image and to change an appearance of the panel by switching the panel between the different optical states.

2. The electronic display of claim 1, wherein the different optical states comprise a first state in which the panel is transparent and a second state in which the panel is opaque.

3. The electronic display of claim 2, wherein the panel is black in the second state.

4. The electronic display of claim 2, wherein the display is transparent when the panel is in the first state.

5. The electronic display of claim 1, wherein, for a first display state, the controller selectively activates the light-emitting elements to display an image and the panel is in a first of the different optical states and, for the second display state, the light-emitting elements are switched off and the panel is in a second of the different optical states.

6. The electronic display of claim 1, wherein the panel comprises a second array of pixels each separately switchable between different optical states.

7. The electronic display of claim 1, wherein each pixel comprises a plurality of subpixels each comprising a light-emitting element of different colors.

8. The electronic display claim 7, wherein each pixel comprises a red, green, and blue light-emitting element or a cyan, magenta, and yellow light-emitting element.

9. The electronic display of claim 7, wherein each light-emitting element is arranged in a corresponding aperture, the aperture being transparent to incident light.

10. The electronic display of claim 7, wherein the aperture has at least one dimension that is at least five times or more larger than a corresponding dimension of the corresponding light-emitting element.

11. The electronic display of claim 7, wherein the aperture has two perpendicular dimensions that are at least five times or more larger than corresponding dimensions of the corresponding light-emitting element.

12. The electronic display of claim 7, wherein the aperture has an area that is 10 times or more larger than a corresponding area of the corresponding light emitting element.

13. The electronic display of claim 7, wherein the aperture has an area that is 50 times or more larger than a corresponding area of the corresponding light emitting element.

14. The electronic display of claim 1, wherein the light-emitting elements are light-emitting diodes.

15. The electronic display of claim 14, wherein the light-emitting diodes are μLEDs.

16. The electronic display of claim 1, wherein the light-emitting elements have a maximum lateral dimension of 50 μm or less.

17. The electronic display of claim 1, wherein the light-emitting elements have a maximum lateral dimension of 10 μm or less.

18. The electronic display of claim 1, wherein the panel comprises the second array of pixels that constitutes a reflective display, a transmissive display, or an emissive display.
